(19) United States
(12) Patent Application Publication
(10) Pub. No.: US 2014/0305677 A1
(43) Pub. Date: Oct. 16, 2014

(54) MASTERBATCH FOR MANUFACTURING AN INSULATING LAYER OF AN ELECTRIC CABLE

(71) Applicant: ARKEMA FRANCE, Colombes Cédex (FR)

(72) Inventors: Alfredo Defrancisci, Lyon (FR); Vincent Palluault, Evreux (FR)

(73) Assignee: ARKEMA FRANCE, Colombes Cédex (FR)

(21) Appl. No.: 14/353,720

(22) PCT Filed: Oct. 19, 2012
(86) PCT No.: PCT/FR2012/052389

§ 371 Date: Apr. 23, 2014

(30) Foreign Application Priority Data
Oct. 24, 2011 (FR) 11.59597

(51) Int. Cl. H01B 3/44; C08L 23/08; C08L 33/08; C08J 3/22

(52) U.S. Cl. CPC H01B 3/447; C08J 3/22; C08L 23/0869; C08L 33/08; C08J 2323/08; C08J 2333/08
USPC 174/110 A; 29/887; 524/562; 523/351

(57) ABSTRACT

A masterbatch including an ethylene copolymer and at least one ethylene comonomer having at least one polar group, an organic peroxide, and an anti-oxidant, the organic peroxide accounting for 0.2 to 100 parts by weight, for 100 parts by weight of the copolymer, and the anti-oxidant accounting for 0.02 to 50 parts by weight, for 100 parts by weight of the copolymer. Also, methods for preparing the masterbatch and to the uses of said masterbatch for manufacturing insulating layers for electric cables and for limiting or preventing the water tree phenomenon for electric cables.

### TECHNICAL FIELD

The present disclosure relates to a masterbatch consisting essentially of a copolymer (A) of ethylene and of at least one ethylenic comonomer having at least one polar group, an organic peroxide (B) and an antioxidant (C), to its process of preparation and to its uses in the manufacture of insulating layers for electric cables and in order to limit or prevent the phenomenon of water treeing of electric cables.

### TECHNOLOGICAL BACKGROUND

An electric wire or an electric cable generally consists of a conducting material coated with one or more layers of polymer materials. The nature and thickness of the various layers depend on the type of electric cable, for example medium-voltage cable (1-35 kV), high-voltage cable (36-132 kV) or very-high-voltage cable (>132 kV).

Among these polymer layers, at least one layer is generally an insulating layer which ensures the electrical insulation of the conducting part of the cable. Crosslinked low density polyethylene (XLPE for “Cross-Linked PolyEthylene”) is most often used to produce the insulating layer as this polymer material has the appropriate electrical resistance properties. However, it has been found that the medium- or high-voltage electric cables comprising polymer insulators are exposed to the phenomenon of electrical treeing when they are used in humid environments.

Water treeing is a phenomenon of deterioration of solid insulators which is expressed by the appearance, inside or at the surface of the insulator, of more or less fine water channels or grooves having an arborescent shape. Water treeing has the effect of bringing about electrical breakdowns and thus of reducing the lifetime of the cables.

Solutions have been introduced in the art in order to prevent the phenomenon of water treeing. It may be considered that there exist three means of preventing the appearance of treeing in cables:

The first technique is physical protection, which consists in protecting the cable using an aluminum “tube” which acts as a barrier to water and moisture. This process is much used for high- and very-high-voltage cables.

The second technique consists in using additives within the insulating polyethylene layer, conventionally compounds of silane type. This technique is generally used for medium-voltage cables.

The third method consists of the incorporation of an ethylene/acrylate copolymer in the insulating polyethylene layer. This third method of incorporation of a copolymer in a polyethylene matrix presents difficulties of implementation.

In order to produce such insulating layers, it is necessary to carry out several stages, for example:
the mixture of the polymers in the form of granules;
the extrusion of the mixture of polymers;
the impregnation of this extruded mixture with peroxides and optional additives;
the extrusion of the mixture impregnated with peroxides in the form of an insulating layer;
the crosslinking of the polymers by radical reaction.

Another possible process consists of:
the mixture of the polymers in the form of granules;
the extrusion of the mixture of polymers;
the introduction into a second extruder of the mixture obtained and its extrusion in the form of an insulating layer, with injection of the peroxides and optional additives during the extrusion;
the crosslinking of the polymers by radical reaction.

Finally, it is also possible to employ a specific metering unit, which is a unit for the direct injection of peroxides denoted by DPI (Direct Peroxide Injection), in the following way:
the continuous introduction of the various polymers in the form of granules and of the peroxides and of the optional additives into the DPI unit;
the extrusion of this mixture in the form of an insulating layer;
the crosslinking of the polymers by radical reaction.

For example, DPI units are manufactured by INOEX et LICO and are mentioned in the patent applications EP 0 472 949 and EP 1 221 702.

The applicant company set itself the objective of providing a process for the production of an insulating layer having properties of combating water treeing which is advantageously simpler, faster to carry out and less expensive than known processes and which in particular does not require the use of highly specific and expensive devices.

This objective was achieved by virtue of the use of a masterbatch which also forms the subject matter of embodiments of the present disclosure.

### SUMMARY

A subject matter of an embodiment of the present disclosure is thus a masterbatch consisting essentially of:
a copolymer (A) of ethylene and of at least one ethylenic comonomer having at least one polar group,
an organic peroxide (B), and
an antioxidant (C),
the total weight of the copolymer (A), of the peroxide (B) and of the antioxidant (C) representing at least 90% of the weight of the masterbatch;
   the organic peroxide (B) representing from 0.2 to 100 parts by weight, per 100 parts by weight of the copolymer (A), and the antioxidant (C) representing from 0.02 to 50 parts by weight, per 100 parts by weight of the copolymer (A).

Embodiments of the disclosure also relate to a process of the preparation of said masterbatch.

According to a first embodiment, the process for the preparation of the masterbatch comprises the stages consisting in:
forming a homogeneous liquid mixture between the organic peroxide (B) and the antioxidant (C);
bringing said liquid mixture into contact with the copolymer (A);
recovering the masterbatch.

According to a second embodiment, the process for the preparation of the masterbatch comprises the stages consisting in:
extruding the copolymer (A) with the antioxidant (C) in order to obtain an extrudate;
bringing the organic peroxide (B) into contact with said extrudate once the latter is at a temperature sufficiently low not to trigger the thermal decomposition of the peroxide;
recovering the masterbatch.

According to a third embodiment, the process for the preparation of the masterbatch comprises the stages consisting in:
extruding the copolymer (A) with the antioxidant (C) in order to obtain an extrudate;
extruding the organic peroxide (B) with said extrudate at a temperature sufficiently high to make possible the extrusion of the copolymer, but sufficiently low not to trigger the thermal decomposition of the peroxide;
recovering the masterbatch.

This masterbatch is intended to be incorporated in a crosslinkable polymer matrix and can be used to limit or prevent the phenomenon of water treeing of electric cables.

The subject matter of embodiments of the present disclosure is thus also the use of said masterbatch in the manufacture of insulating layers on electric cables. The process for the manufacture of an insulating layer on electric cables comprising the stages consisting in:
diluting the masterbatch described above in a crosslinkable polymer matrix in order to obtain a polymer composition;
extruding said polymer composition over an electric cable;
bringing about the crosslinking of the extruded polymer composition;
   is thus also the subject matter of embodiments of the present disclosure.

### DETAILED DESCRIPTION

In the present disclosure, the term “consisting essentially of” is understood to mean the fact that the total weight of the copolymer (A), of the peroxide (B) and of the antioxidant (C) represents at least 90% of the weight of the masterbatch. The optional components of the masterbatch other than the copolymer (A), the peroxide (B) and the antioxidant (C) thus represent at most 10% of the weight of the masterbatch. These other components can be chosen from the compounds conventionally present in an electric cable insulating layer, for example stabilizers, technical adjuvants, scorch retarders, crosslinking accelerators, flame-retardant agents, acid scavengers or fillers.

However, the presence of components other than the copolymer (A), the peroxide (B) and the antioxidant (C) in the masterbatch may not be desirable when said masterbatch is used to manufacture insulating layers for combating water treeing on medium- or high-voltage electric cables. This is because the presence of other components can create inhomogeneities in the polymer, which can promote risks of electrical breakdowns. Advantageously, the optional components of the masterbatch other than the copolymer (A), the peroxide (B) and the antioxidant (C) thus represent at most 5%, more preferably at most 1% and more preferably still at most 0.1% of the weight of the masterbatch. According to an advantageous embodiment, the masterbatch which is a subject matter of embodiments of the present disclosure consists solely of the copolymer (A), the peroxide (B) and the antioxidant (C). However, the presence of possible impurities which the components include as a result of their process of synthesis cannot be excluded.

The constituents of the masterbatch according to embodiments of the disclosure will now be described in more detail.

The copolymer (A) comprises an ethylene comonomer and at least one ethylenic comonomer having at least one polar group. The copolymer (A) can optionally comprise other comonomer(s).

Preferably, the ethylenic comonomer having at least one polar group can be chosen from the group consisting of:
vinyl esters, such as vinyl acetate and vinyl pivalate;
alkyl and hydroxyalkyl acrylates and methacrylates, such as methyl acrylate, methyl methacrylate, ethyl acrylate, ethyl methacrylate, butyl acrylate, butyl methacrylate, hydroxyethyl acrylate and hydroxyethyl methacrylate;
unsaturated carboxylic acids, such as acrylic acid, methacrylic acid, maleic acid and fumaric acid;
acrylic acid derivatives or methacrylic acid derivatives, such as acrylonitrile, methacrylonitrile, acrylamide and methacrylamide; and
vinyl ethers, such as methyl vinyl ether and phenyl vinyl ether.

Among these comonomers, alkyl acrylates or methacrylates where the alkyl has from 1 to 4 carbon atoms are preferred. The comonomers which are particularly preferred are n-butyl acrylate, isobutyl acrylate, 2-ethylhexyl acrylate, cyclohexyl acrylate, n-octyl acrylate, methyl methacrylate and ethyl methacrylate.

Preferably, the copolymer (A) consists of an ethylene comonomer and an ethylenic comonomer having at least one polar group.

Advantageously, the copolymer (A) comprises from 10% to 60% by weight, preferably from 15% to 25%, of ethylenic comonomer having at least one polar group, with respect to the total weight of the copolymer.

Copolymers exhibiting the above technical characteristics are available commercially from Arkema under the Lotryl® trade name.

Preferably, the organic peroxide (B) included in the masterbatch which is a subject matter of embodiments of the present disclosure has the following formula (I):

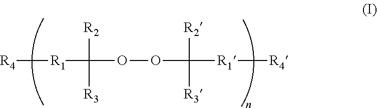

in which:
n is an integer equal to 1, 2, 3 or 4;
R₁ and R₁′ are each, independently of one another, an oxygen atom or a saturated or partially unsaturated, linear or branched, divalent C₁ to C₅ hydrocarbon radical and preferably an unsubstituted linear C₁ to C₅ alkylene chain,
R₂, R₂′, R₃ and R₃′ are each, independently of one another, a saturated or partially unsaturated, linear or branched, C₁ to C₅ hydrocarbon radical and preferably an unsubstituted linear C₁ to C₅ alkyl group,
R₄ and R₄′ are each, independently of one another, a hydrogen atom or a saturated or partially unsaturated, linear or branched, C₁ to C₅ hydrocarbon radical and preferably an unsubstituted linear C₁ to C₅ alkyl group.

According to a first embodiment, in the formula (I):
R₁ and R₁′ are each, independently of one another, an alkylene chain of formula —(CH₂)— or —(CH₂—CH₂)—;
R₂, R₂′, R₃ and R₃′ are each, independently of one another, chosen from the group consisting of methyl, ethyl, 1-propyl, isopropyl, 1-butyl, isobutyl and tert-butyl, preferably methyl;
R₄ and R₄′ are each, independently of one another, chosen from the group consisting of the hydrogen atom, methyl, ethyl, 1-propyl, isopropyl, 1-butyl, isobutyl and tert-butyl, preferably the hydrogen atom.

Preferably, the organic peroxide (B) is chosen from the group consisting of 2,5-dimethyl-2,5-di(tert-butylperoxy)hexane, di(tert-amyl) peroxide, di(tert-butyl) peroxide and tert-butyl cumyl peroxide. These organic peroxides are available commercially from Arkema under the Luperox® 101, Luperox® DTA, Luperox® DI, Luperox® DC, Luperox® DCP and Luperox® 801 trade names.

More preferably still, the organic peroxide (B) is 2,5-dimethyl-2,5-di(tert-butylperoxy)hexane of formula (II):

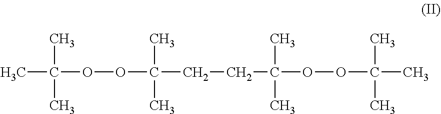 [SMILES: CC(C)(C)OOC(C)(C)CCC(C)(C)OOC(C)(C)C]

More preferably still, the organic peroxide (B) is tert-butyl cumyl peroxide of formula (III):

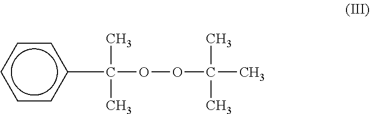

More preferably still, the organic peroxide (B) is dicumyl peroxide of formula (IV):

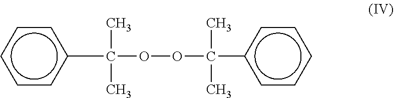

According to another embodiment, in the formula (I):
n is equal to 1;
R₄ and R₄′ together form a carbocycle or heterocycle comprising from 3 to 14 carbon atoms and optionally 1 to 4 heteroatoms chosen from O, N, P, S and Si.

Preferably, an organic peroxide (B) of this type is 3,6,9-triethyl-3,6,9-trimethyl-1,4,7-triperoxonane of formula (V):

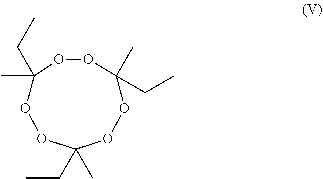 [SMILES: CCC1(C)OOC(C)(CC)OOC(C)(CC)OO1]

This organic peroxide is available commercially from Akzo Nobel under the Trigonox® 301 trade name.

In the context of embodiments of the present disclosure, the organic peroxide (B) can be an organic peroxide as described above or a mixture of several of said organic peroxides.

In the masterbatch which is a subject matter of embodiments of the present disclosure, the organic peroxide (B) represents from 0.2 to 100 parts by weight, per 100 parts by weight of the copolymer (A). More preferably, the organic peroxide (B) represents from 2 to 50 parts by weight, per 100 parts by weight of the copolymer (A). More preferably still, the organic peroxide (B) represents from 9 to 15 parts by weight, per 100 parts by weight of the copolymer (A).

Preferably, the antioxidant (C) can be chosen from those conventionally used in polymer matrices, in particular from sterically hindered or semihindered phenols, optionally substituted by one or more functional groups, aromatic amines, sterically hindered aliphatic amines, organic phosphates and thio compounds.

Such antioxidants are available commercially from BASF under the Irganox® 1035 and Irganox® PS802 trade names.

In embodiments of the present disclosure, the antioxidant (C) can be an antioxidant or a mixture of several antioxidants.

In the masterbatch which is a subject matter of embodiments of the present disclosure, the antioxidant (C) represents from 0.02 to 50 parts by weight, per 100 parts by weight of the copolymer (A). More preferably, the antioxidant (C) represents from 0.1 to 10 parts by weight, per 100 parts by weight of the copolymer (A). More preferably still, the antioxidant (C) represents from 1 to 3 parts by weight, per 100 parts by weight of the copolymer (A).

As indicated above, embodiments of the present disclosure also relate to a process for the preparation of the masterbatch.

According to a first embodiment, this process comprises the stages consisting in:
forming a homogeneous liquid mixture between the organic peroxide (B) and the antioxidant (C);
bringing said liquid mixture into contact with the copolymer (A);
recovering the masterbatch.

The homogeneous liquid mixture of the organic peroxide (B) and of the antioxidant (C) can be prepared in different ways according to the nature of the compounds. If the organic peroxide (B) is in a liquid form, the mixture can be obtained by adding the antioxidant (C), itself in the liquid or solid form, to the organic peroxide (B) and by mixing using magnetic or mechanical stirring. If the organic peroxide (B) is in the solid form, the homogeneous liquid mixture can be obtained by preheating of the organic peroxide (B) above its melting point, in order to subsequently add the antioxidant (C) and to carry out the mixing. The heating can be carried out, for example, using a water bath.

In order to obtain a complete dissolution of the antioxidant (C) in the organic peroxide (B), and thus a homogeneous liquid mixture, an additional stage consisting in heating the mixture, for example using a water bath, can be carried out. The temperature of the heating can be between 30° C. and 80° C., preferably between 40° C. and 70° C.

The natures and the relative amounts of the organic peroxide (B) and of the antioxidant (C) are chosen so that their liquid mixture is homogeneous, that is to say that they are completely miscible together to the naked eye.

Alternatively, the homogeneous liquid mixture between the organic peroxide (B) and the antioxidant (C) can be obtained by dissolving the organic peroxide (B) and the antioxidant (C), it being possible for these two compounds to be in the liquid or solid form, in an appropriate solvent. The solvent can preferably be removed during a subsequent stage of preparation of the masterbatch, preferably by evaporation. The choice of the solvent can be made by a person skilled in the art according to the solubility of the different components and according to the boiling point of the solvent. In this embodiment, the organic peroxide (B) and the antioxidant (C) are preferably chosen from relatively nonvolatile compounds, so that they are not removed at the same time as the solvent.

The liquid mixture obtained is brought into contact with the copolymer (A). The copolymer (A) is preferably in the form of granules. The contacting operation is carried out so that the liquid mixture is absorbed by the copolymer (A). The absorption of the liquid mixture by the copolymer (A) may or may not be complete.

The operation of bringing the liquid mixture into contact with the copolymer (A) can be carried out by steeping, accompanied or not accompanied by mixing.

The operation in which a liquid mixture is brought into contact with the copolymer (A) can be carried out at ambient temperature (approximately 25° C.) or with heating. The use of heating is advantageous if, in particular, the liquid mixture is only homogeneous at a temperature greater than ambient temperature. The stage of bringing into contact can thus be carried out at a temperature of between 40° C. and 80° C., preferably between 50° C. and 70° C.

According to an advantageous embodiment, the copolymer (A) and the liquid mixture are introduced into a mixer. Mechanical mixing is carried out so that the copolymer (A) is impregnated with the liquid mixture. The mechanical mixing is then interrupted and the steeping is continued until the liquid mixture has been completely absorbed by the copolymer (A).

The duration of the contacting stage can be adjusted by a person skilled in the art according to the rate at which the liquid mixture is absorbed by the copolymer (A). This stage can, for example, last between 5 minutes and 12 hours.

It is optionally possible to bring the copolymer (A) into contact with components other than the peroxide (B) and the antioxidant (C). These other components, which have been described above, can be added to the homogeneous liquid mixture, before or after its formation, or can be independently brought into contact with the copolymer (A), before, during or after the stage of bringing into contact with the liquid mixture.

On conclusion of this stage in which the liquid mixture is brought into contact with the copolymer (A), the copolymer (A) impregnated with the peroxide (B) and with the antioxidant (C) is recovered. The relative proportions of copolymer (A), of organic peroxide (B), of antioxidant (C), and optionally of other components are chosen so that the organic peroxide (B) represents from 0.2 to 100 parts by weight, per 100 parts by weight of the copolymer (A), and the antioxidant (C) represents from 0.02 to 50 parts by weight, per 100 parts by weight of the copolymer (A). In particular, these proportions can be adapted according to whether or not the absorption of the liquid mixture by the copolymer (A) is complete.

According to a second embodiment, the process for the preparation of a masterbatch comprises the stages consisting in:
extruding the copolymer (A) with the antioxidant (C) in order to obtain an extrudate;
bringing the organic peroxide (B) into contact with said extrudate once the latter is at a temperature sufficiently low not to trigger the thermal decomposition of the peroxide;
recovering the masterbatch.

The extrusion of the copolymer (A) with the antioxidant (C) can be carried out according to techniques known to a person skilled in the art, for example using a single-screw or twin-screw extruder. The antioxidant (C) can be provided in the liquid form or the solid form. The temperature of the extrusion is adapted, as is known to a person skilled in the art, to the melting point of the copolymer (A). The extrudate is preferably recovered in the form of granules.

Said extrudate is subsequently brought into contact with the organic peroxide (B) once the extrudate is at a temperature sufficiently low not to trigger the thermal decomposition of the peroxide. The extrudate can be actively cooled or else it can be left to freely cool. The operation of bringing into contact with the organic peroxide (B) can be carried out such as has been described above for the first embodiment of the process of the preparation of the masterbatch. In particular, if the organic peroxide (B) is not liquid at ambient temperature, the latter can be heated.

According to a third embodiment, the process for the preparation of the masterbatch comprises the stages consisting in:
extruding the copolymer (A) with the antioxidant (C) in order to obtain an extrudate;
extruding the organic peroxide (B) with said extrudate at a temperature sufficiently high to make possible the extrusion of the copolymer, but sufficiently low not to trigger the thermal decomposition of the peroxide;
recovering the masterbatch.

The extrusion of the copolymer (A) with the antioxidant (C) can be carried out such as has been described above for the second embodiment of the process for the preparation of the masterbatch.

The extrudate is subsequently extruded a second time with the organic peroxide (B). The temperature of the extrusion is adapted, as is known to a person skilled in the art, to the melting point of the copolymer (A), so as to make possible the extrusion. However, the temperature of this second extrusion is adjusted so that the temperature is sufficiently low not to trigger the thermal decomposition of the peroxide. The adjustment of the extrusion temperature forms part of the know-how of a person skilled in the art.

Whatever the method of carrying out its process of preparation, the masterbatch thus obtained is stable over time. Advantageously, the contents of organic peroxide (B) and of antioxidant (C) do not vary significantly after storage under normal conditions for twelve months at ambient temperature, that is to say below 30° C. These masterbatches can be transported in bags or in kegs from the production center to the conversion center.

This masterbatch can advantageously be used to manufacture insulating layers on electric cables. The electric cable can in particular be a medium-voltage cable (1-35 kV) or a high-voltage cable (36-132 kV).

Another subject matter of embodiments of the present disclosure is a process for the manufacture of an insulating layer on electric cables comprising the stages consisting in:
diluting the masterbatch described above in a crosslinkable polymer matrix in order to obtain a polymer composition;
extruding said polymer composition over an electric cable;
bringing about the crosslinking of the extruded polymer composition.

The dilution stage can be carried out by means of any device conventionally used in plastics technology, in particular using internal mixers, or (double- or triple-roll) roll mills. The dilution stage can also consist of the introduction of the compounds into the hopper of an extruder using gravimetric feeders, for example. It is also possible to carry out this diluting using a side extruder.

The crosslinkable polymer matrix preferably consists of polyethylene, more preferably of low-density polyethylene (LDPE). It is preferably provided in the form of granules.

According to a first embodiment, the masterbatch and the crosslinkable polymer matrix are introduced into the feed hopper of the extruder, without the addition of other component. The degree of dilution by weight of the masterbatch in the crosslinkable polymer matrix (masterbatch/crosslinkable polymer matrix) can be between 0.1/99.9 and 60/40, preferably between 5/95 and 30/70, and more preferably still between 10/90 and 20/80. This degree can vary according to the composition of the masterbatch.

According to a second embodiment, the masterbatch and the crosslinkable polymer matrix are introduced into the feed hopper of the extruder, furthermore with an additional amount of copolymer (A).

Whatever the embodiments employ, this dilution stage makes it possible to obtain a polymer composition.

Advantageously, a polymer composition is thus obtained which comprises the crosslinkable polymer, the copolymer (A), the organic peroxide (B) and the antioxidant (C). Other components can optionally be present, such as, for example, stabilizers, technical adjuvants, scorch retarders, crosslinking accelerators, flame-retardant agents, acid scavengers or fillers. These optional components can originate from the masterbatch or be added during the dilution of the masterbatch in the crosslinkable polymer matrix.

Preferably, the copolymer (A) represents from 0.2% to 50% by weight, more preferably from 5% to 20% by weight and more preferably still from 10% to 15% by weight, of the polymer composition.

In addition, the organic peroxide (B) preferably represents from 0.1 to 100 parts by weight and more preferably from 0.5 to 2 parts by weight, per 100 parts of the total weight of the crosslinkable polymer and copolymer (A).

Furthermore, the antioxidant (C) preferably represents from 0.01 to 1 part by weight and more preferably from 0.2 to 0.3 part by weight, per 100 parts of the total weight of the crosslinkable polymer and copolymer (A).

The polymer composition obtained is shaped by extrusion so as to form a layer around an electric cable. The extrusion can be simple or can consist of a coextrusion with other polymer compositions. The extrusion can be carried out directly on the conducting material forming the electric cable. Other layers can conventionally be positioned between the conducting material and the insulating layer, for example an internal semiconducting layer.

The extruded polymer composition is subsequently subjected to a crosslinking stage. The organic peroxide (B) present in the polymer composition makes possible the crosslinking of the crosslinkable polymer. The crosslinking stage can vary according to the nature of the materials used and the size of the electric cable. Preferably, this stage consists in subjecting the extruded polymer composition to a high temperature, preferably of between 100° C. and 450° C., more preferably between 110° C. and 400° C.

The insulating layer obtained on the electric cable has a thickness advantageously of between 1 millimeter and 5 centimeters. For a medium-voltage electric cable (1-35 kV), the thickness of the insulating layer can be approximately 5 millimeters. For a high voltage electric cable (36-132 kV), the thickness of the insulating layer can be several centimeters.

The crosslinked polymer composition constitutes an insulating layer on the electric cable. The use of the masterbatch according to embodiments of the present disclosure makes it possible to easily manufacture this insulating layer without using several specific extrusion devices or items of equipment, such as a direct peroxide injection unit.

In addition, it has been found that the crosslinking density obtained with the masterbatch according to embodiments of the present disclosure is comparable to that obtained with a masterbatch not comprising antioxidant (C). The presence of the antioxidant (C) in the masterbatch thus does not detrimentally affect the crosslinking density of the insulating layer.

A better understanding of embodiments of the present disclosure will be obtained in the light of the following nonlimiting and purely illustrative examples.

### EXAMPLE

### Starting Materials Used

TABLE 1

| Starting | | Trade | | |
|---|---|---|---|---|
| materials | | name | Ref. | Supplier |
| Copolymer | Random copolymer | Lotryl ® | 17BA04 | Arkema |
| (A) | of ethylene and | | | |
| | butyl acrylate | | | |
| Organic | tert-butyl cumyl | Luperox ® | 801 | Arkema |
| peroxide (B) | peroxide | | | |
| | 2,5-dimethyl- | Luperox ® | 101 | Arkema |
| | 2,5-di(tert- | | | |
| | butylperoxy)- | | | |
| | hexane | | | |
| Antioxidant | | Irganox ® | 1035 | BASF |
| (C) | | Irganox ® | PS802 | |
| Polyethylene | LDPE | | BPD | INEOS |
| matrix | | | 2000 | |

### Preparation of Two Masterbatches

TABLE 2

| | | | Theoretical |
|---|---|---|---|
| | | | amounts |
| Masterbatch | Copolymer | Lotryl ® 17BA04 | q.s. |
| 1 | (A) | | for 100% |
| | Organic | Luperox ® 801 | 11.50% |
| | peroxide (B) | | |
| | Antioxidant | Irganox ® 1035 | 1.08% |
| | (C) | Irganox ® PS802 | 1.08% |
| Masterbatch | Copolymer | Lotryl ® 17BA04 | q.s. |
| 2 | (A) | | for 100% |
| | Organic | Luperox ® 101 | 11.50% |
| | peroxide (B) | | |
| | Antioxidant | Irganox ® 1035 | 1.08% |
| | (C) | Irganox ® PS802 | 1.08% |

The two masterbatches were prepared according to the same protocol described below.

The peroxide (B) and then the antioxidant (C) were introduced into a flask. The flask was placed in a water bath at a temperature of 57° C. and the peroxide and antioxidant mixture were stirred with a magnetic bar in order to obtain a homogeneous liquid mixture.

The copolymer (A) in the form of granules was introduced into a 250 ml Schott® glass flask.

The homogeneous liquid mixture of peroxide and antioxidant was heated up on the water bath to 60° C. and then the desired amount was withdrawn and introduced into the glass flask containing the copolymer (A).

The flask was placed in an item of equipment which makes possible continuous stirring and the temperature was maintained at 60° C. until the homogeneous liquid mixture of peroxide and antioxidant had been completely absorbed by the copolymer (A).

For masterbatch 1, the liquid mixture was absorbed in three hours. For masterbatch 2, the liquid mixture was absorbed in six hours.

It was noted that the granules of copolymer (A), which are fundamentally translucent, became white and opaque after absorption.

### Accelerated Aging Test on the Masterbatches

Approximately 20 g of masterbatch were weighed into 100 ml Schott® glass flasks. They were subjected to aging in an oven for seven days at 50° C.

After seven days, HPLC or GC measurements made it possible to determine the change in the content of peroxide and antioxidants in the two masterbatches studied.

TABLE 3

| | | Starting | |
|---|---|---|---|
| | | amount | Amount after aging |
| Masterbatch | Luperox ® 801 | 12.41% | 12.52% |
| 1 | Irganox ® 1035 | 0.97% | 0.87% |
| | Irganox ® PS802 | 1.06% | 1.02% |
| Masterbatch | Luperox ® 101 | 11.51% | 11.47%% |
| 2 | Irganox ® 1035 | 0.95% | 0.91% |
| | Irganox ® PS802 | 0.87% | 0.90% |

The difference between the measured and theoretical values is explained by the quantitative measurement technique used.

As regards only the change in the contents obtained, it has been found that the variation before and after aging is not significantly different.

The two masterbatches prepared are thus stable over time.

### Preparation of a Crosslinked Polymer Composition

In order to produce 55 g of the polymer composition, 47.5 g of LPDE were introduced into an internal mixer of N50 type equipped with cam rotors (Brabender) which is heated to 120° C.

7.5 g of masterbatch 1 or 2 were added to the mixer and the mixing was continued for two minutes at 50 revolutions/minute.

The mixture was subsequently recovered from the mixer. From the metering of the starting materials down to the recovery of the mixture, the operation lasts approximately six minutes.

The resulting mixture was passed into a Gumix® colander at a temperature of 120° C. through a gap of 1.5 mm. A sheet of homogeneous appearance was obtained and was used for the following test:

### Crosslinking Density Test

The change in the viscoelastic torque of a crosslinkable mixture was measured over time using the RPA (Rubber Process Analyzer) 2000 from Alpha Technologies.

The values obtained correspond to a mean over three tests.

TABLE 4
Masterbatch 1

| | | |
|---|---|---|
| MH-ML (dNm) | T90 (m:s) | Ts2 (m:s) |

Mean value

| | | |
|---|---|---|
| 24.09 | 07:46 | 00:59 |

Standard deviation

| | | |
|---|---|---|
| 0.54 | 00:01 | 00:01 |

Masterbatch 2

| | | |
|---|---|---|
| MH-ML (dNm) | T90 (m:s) | Ts2 (m:s) |

Mean value

| | | |
|---|---|---|
| 24.59 | 08:30 | 01:01 |

Standard deviation

| | | |
|---|---|---|
| 0.05 | 00:01 | 00:01 |

The values for MH-ML (dNm) are directly corelatable with the crosslinking density. The values obtained for the crosslinked LDPE polymer compositions prepared with masterbatches 1 and 2 show that these compositions have a correct crosslinking density.

The T90 values represent the time necessary to achieve 90% of the maximum crosslinking density. The Ts2 values represent the scorch or precrosslinking time of the mixture studied. The T90 and Ts2 values obtained at 180° C. for the crosslinked LDPE polymer compositions prepared with masterbatches 1 and 2 are in accordance with expectations.

1. A masterbatch consisting essentially of:
a copolymer of ethylene and of at least one ethylenic comonomer having at least one polar group,
an organic peroxide, and
an antioxidant,
the total weight of the copolymer, of the peroxide and of the antioxidant representing at least 90% of the weight of the masterbatch;
the organic peroxide representing from 0.2 to 100 parts by weight, per 100 parts by weight of the copolymer, and the antioxidant representing from 0.02 to 50 parts by weight, per 100 parts by weight of the copolymer.

2. The masterbatch as claimed in claim 1, wherein the masterbatch consists solely of the copolymer, the peroxide and the antioxidant.

3. The masterbatch as claimed in claim 1, wherein the ethylenic comonomer having at least one polar group is chosen from the group consisting of:
vinyl esters;
alkyl and hydroxyalkyl acrylates and methacrylates;
unsaturated carboxylic acids;
acrylic acid derivatives or methacrylic acid derivatives; and
vinyl ethers.

4. The masterbatch as claimed in claim 1, wherein the ethylenic comonomer having at least one polar group is chosen from the group consisting of n-butyl acrylate, isobutyl acrylate, 2-ethylhexyl acrylate, cyclohexyl acrylate, n-octyl acrylate, methyl methacrylate and ethyl methacrylate.

5. The masterbatch as claimed in claim 1, wherein the organic peroxide has the following formula (I): 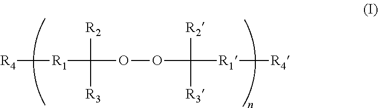
in which:
n is an integer equal to 1, 2, 3 or 4;
R₁ and R₁′ are each, independently of one another, an oxygen atom or a saturated or partially unsaturated, linear or branched, divalent C₁ to C₅ hydrocarbon radical,
R₂, R₂′, R₃ and R₃′ are each, independently of one another, a saturated or partially unsaturated, linear or branched, C₁ to C₅ hydrocarbon radical,
R₄ and R₄′ are each, independently of one another, a hydrogen atom or a saturated or partially unsaturated, linear or branched, C₁ to C₅ hydrocarbon radical.

6. The masterbatch as claimed in claim 1, wherein the organic peroxide represents from 2 to 50 parts by weight, per 100 parts by weight of the copolymer.

7. The masterbatch as claimed in claim 1, wherein the antioxidant represents from 0.1 to 10 parts by weight, per 100 parts by weight of the copolymer.

8. A process for the preparation of the masterbatch as claimed in claim 1, comprising the stages of:
forming a homogeneous liquid mixture between the organic peroxide and the antioxidant;
bringing said liquid mixture into contact with the copolymer;
recovering the masterbatch.

9. A process for the preparation of the masterbatch as claimed in claim 1, comprising the stages of:
extruding the copolymer with the antioxidant in order to obtain an extrudate;
bringing the organic peroxide into contact with said extrudate once the latter is at a temperature sufficiently low not to trigger the thermal decomposition of the peroxide;
recovering the masterbatch.

10. A process for the preparation of the masterbatch as claimed in claim 1, comprising the stages of:
extruding the copolymer with the antioxidant in order to obtain an extrudate;
extruding the organic peroxide with said extrudate at a temperature sufficiently high to make possible the extrusion of the copolymer, but sufficiently low not to trigger the thermal decomposition of the peroxide;
recovering the masterbatch.

11. Insulating layers on electric cables, the insulating layers comprising the masterbatch as claimed in claim 1.

12. A method of limiting the phenomenon of water treeing of electric cables, the method comprising forming a layer of the electric cable with the masterbatch as claimed in claim 1.

13. A process for the manufacture of an insulating layer on electric cables comprising the stages of:
diluting the masterbatch as claimed in claim 1 in a crosslinkable polymer matrix in order to obtain a polymer composition;
extruding said polymer composition over an electric cable;
bringing about the crosslinking of the extruded polymer composition.
